(19) United States
(12) Patent Application Publication
(10) Pub. No.: US 2024/0172722 A1
(43) Pub. Date: May 30, 2024

(54) ANIMAL CLEANING DEVICE

(71) Applicant: Charlene M. Piskula, Coplay, PA (US)

(72) Inventor: Charlene M. Piskula, Coplay, PA (US)

(21) Appl. No.: 17/994,489

(22) Filed: Nov. 28, 2022

(51) Int. Cl. A01K 13/00

(52) U.S. Cl. CPC A01K 13/001

(57) ABSTRACT

An animal cleaning device, including a cleaning surface to clean and scrub at least a portion of a body of an animal in response to receiving the animal thereon, and a storing body, including a base to be removably disposed on at least a portion of an external surface and receive the cleaning surface thereon, a plurality of walls disposed around at least a portion of a perimeter of a first side of the base to angularly extend away from the base with respect to a direction, and a friction surface disposed on at least a portion of a second side of the base to prevent slipping of the base while disposed on the external surface.

### BACKGROUND

### 1. Field

The present general inventive concept relates generally to animal cleaning, and particularly, to an animal cleaning device.

### 2. Description of the Related Art

Pets are popular animal companions for many people. Moreover, some types of animals, such as dogs and/or cats are susceptible to collecting dirt while roaming in an outdoor environment.

Thus, some pet owners will need to prepare to clean the pet upon returning indoors. Cleaning the pet is important because the pet can leave a trail of residue within a house. Moreover, the pet could potentially carry a harmful object and/or a pest (e.g., ticks, fleas) that could cause injury to the pet. Currently, a pet owner will often have to cleanse the pet using a bathtub, a washcloth, and/or soap. However, this method requires leading the pet to a particular area of the house, which can already lead to dirty floors.

Therefore, there is a need for an animal cleaning device that can be immediately available for cleaning the pet prior to entering the house.

### SUMMARY

The present general inventive concept provides an animal cleaning device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an animal cleaning device, including a cleaning surface to clean and scrub at least a portion of a body of an animal in response to receiving the animal thereon, and a storing body, including a base to be removably disposed on at least a portion of an external surface and receive the cleaning surface thereon, a plurality of walls disposed around at least a portion of a perimeter of a first side of the base to angularly extend away from the base with respect to a direction, and a friction surface disposed on at least a portion of a second side of the base to prevent slipping of the base while disposed on the external surface.

The cleaning surface may at least partially absorb at least one liquid therein.

The plurality of walls may prevent the at least one liquid within the cleaning surface from moving off the base.

The animal cleaning device may further include a fragrant agent disposed within at least a portion of the cleaning surface to emit at least one scent known to be attractive to the animal.

The fragrant agent may be embedded within material used to construct the cleaning surface.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a top isometric view of an animal cleaning device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Animal Cleaning Device 100
Cleaning Surface 110
Storing Body 120
Base 121
Walls 122
Friction Surface 123
Fragrant Agent 130

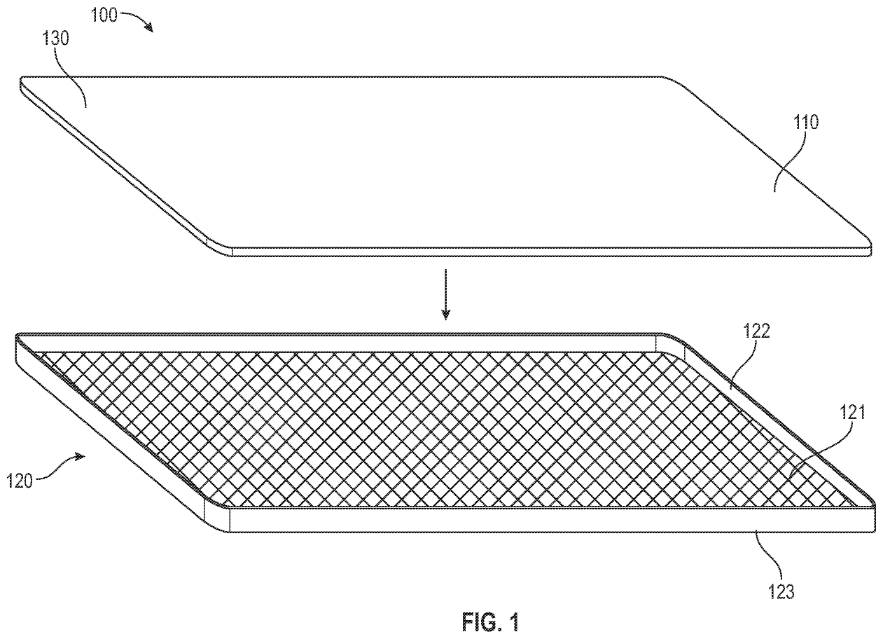

FIG. 1 illustrates a top isometric view of an animal cleaning device 100, according to an exemplary embodiment of the present general inventive concept.

The animal cleaning device 100 may be constructed from at least one of metal, plastic, wood, cloth, and rubber, etc., but is not limited thereto. Also, the animal cleaning device 100 may be bisphenol A (BPA) free.

The animal cleaning device 100 may include a cleaning surface 110, a storing body 120, and a fragrant agent 130, but is not limited thereto.

The cleaning surface 110 may include a sponge, a bamboo cloth, a scrubber, a plurality of bristles, and a loofah, but is not limited thereto.

The cleaning surface 110 may receive at least one foot of an animal thereon. The cleaning surface 110 may at least partially absorb at least one liquid therein. For example, the cleaning surface 110 may at least partially absorb water, a cleaning agent, a soap, a shampoo, a detergent, and/or any other liquid known to one of ordinary skill in the art. As such, the cleaning surface 110 may facilitate cleaning and/or scrubbing the at least one foot of the animal. Although the cleaning surface 110 is referred to as cleaning the at least one foot, the cleaning surface 110 may be used to clean and/or scrub any other part of a body of the animal. Accordingly, the cleaning surface 110 may reduce and/or remove dirt, mud, soil, sand, and/or debris from the at least one foot of the animal in response to cleaning and/or scrubbing the at least one foot thereon.

The storing body 120 may include a base 121, a plurality of walls 122, and a friction surface 123, but is not limited thereto.

The base 121 may be removably disposed on at least a portion of an external surface, such as a ground surface. The base 121 may be stable on the external surface due to having a planar shape. Also, the base 121 may receive the cleaning surface 110 thereon.

Furthermore, the base 121 may have a textured surface, such as a rubber surface and/or a knurled surface. The base 121 may prevent the cleaning surface 110 from moving away therefrom due to the textured surface.

The plurality of walls 122 may be disposed around at least a portion of a perimeter of a first side of the base 121. In other words, the plurality of walls 122 may at least partially surround the perimeter of the base 121. Moreover, the plurality of walls 122 may be angularly (e.g., perpendicularly) disposed away from the base 121 with respect to a direction. As such, the plurality of walls 122 may extend away from and/or be elevated with respect to the base 121. Accordingly, the plurality of walls 122 may prevent the at least one liquid within the cleaning surface 110 from moving (i.e., leaking) off the base 121, such that the plurality of walls 122 may keep the at least one liquid on the base 121.

The friction surface 123 may include a rubber surface, a knurled surface, and a textured surface (e.g., a plurality of bubbled protrusions extending away therefrom), but is not limited thereto.

The friction surface 123 may be disposed on at least a portion of a second side of the base 121 opposite with respect to the first side of the base 121. The friction surface 123 may increase a friction level of the base 121 while disposed on the external surface. As such, the friction surface 123 may prevent slipping of the base 121 while disposed on the external surface, such as during use by the animal.

Furthermore, collectively, the cleaning surface 110 and/or the storing body 120 may be portable, such that the cleaning surface 110 and/or the storing body 120 may be moved and/or disposed at any location.

The fragrant agent 130 may include a perfume, a cologne, a scent, and an odor, but is not limited thereto.

The fragrant agent 130 may be disposed on and/or within at least a portion of the cleaning surface 110. Also, the fragrant agent 130 may be embedded and/or constructed within material used to construct the cleaning surface 110 (e.g., the same material used to make the cleaning surface 110). The fragrant agent 130 may emit at least one scent known in the art to be attractive for the animal (e.g., common knowledge, via scientific experimentation). For example, the fragrant agent 130 may smell like beef for a dog and/or catnip for a cat. As such, the fragrant agent 130 may attract the animal thereto.

Therefore, the animal cleaning device 100 may allow the animal to be cleaned at any location, such as an entrance to a building (e.g., a house). Also, the animal cleaning device 100 may prevent spread of dirt and/or debris by the animal by encouraging cleaning upon entry to the building.

The present general inventive concept may include an animal cleaning device 100, including a cleaning surface 110 to clean and scrub at least a portion of a body of an animal in response to receiving the animal thereon, and a storing body 120, including a base 121 to be removably disposed on at least a portion of an external surface and receive the cleaning surface 110 thereon, a plurality of walls 122 disposed around at least a portion of a perimeter of a first side of the base 121 to angularly extend away from the base 121 with respect to a direction, and a friction surface 123 disposed on at least a portion of a second side of the base 121 to prevent slipping of the base 121 while disposed on the external surface.

The cleaning surface 110 may at least partially absorb at least one liquid therein.

The plurality of walls 122 may prevent the at least one liquid within the cleaning surface 110 from moving off the base 121.

The animal cleaning device 100 may further include a fragrant agent 130 disposed within at least a portion of the cleaning surface 110 to emit at least one scent known to be attractive to the animal.

The fragrant agent 130 may be embedded within material used to construct the cleaning surface 110.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An animal cleaning device, comprising:
a cleaning surface to clean and scrub at least a portion of a body of an animal in response to receiving the animal thereon; and
a storing body, comprising:
a base to be removably disposed on at least a portion of an external surface and receive the cleaning surface thereon,
a plurality of walls disposed around at least a portion of a perimeter of a first side of the base to angularly extend away from the base with respect to a direction, and
a friction surface disposed on at least a portion of a second side of the base to prevent slipping of the base while disposed on the external surface.

2. The animal cleaning device of claim 1, wherein the cleaning surface at least partially absorbs at least one liquid therein.

3. The animal cleaning device of claim 2, wherein the plurality of walls prevent the at least one liquid within the cleaning surface from moving off the base.

4. The animal cleaning device of claim 1, further comprising:
a fragrant agent disposed within at least a portion of the cleaning surface to emit at least one scent known to be attractive to the animal.

5. The animal cleaning device of claim 4, wherein the fragrant agent is embedded within material used to construct the cleaning surface.
